(19) United States
(12) Patent Application Publication
(10) Pub. No.: US 2009/0242034 A1
(43) Pub. Date: Oct. 1, 2009

(54) FLUID CONTROL APPARATUS

(75) Inventor: Thomas A. Morrison, Delta, BC (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: 14007 MINING INC., Richmond, BC (CA)

(21) Appl. No.: 11/721,151

(22) PCT Filed: Dec. 6, 2005
(86) PCT No.: PCT/CA2005/001856

§ 371 Date: Jan. 28, 2008

Related U.S. Application Data
(60) Provisional application No. 60/634,052, filed on Dec. 7, 2004.

(51) Int. Cl. F16K 17/36

(52) U.S. Cl. 137/2; 137/468

(57) ABSTRACT

A method and apparatus for controlling the flow of a fluid past a device having a flow adjusting device comprising transmitting a temperature to a thermally reactive material having a coefficient of thermal expansion which produces a volume change in the thermally reactive material in response to a change in the temperature. The thermally reactive material is enclosed within a container having a movable portion which is moved in response to the volume change of the thermally reactive material and the movement of the movable portion is applied to actuate the flow adjusting device. The flow adjusting device may comprise a fluid propulsion device such as a fan or pump or a throttling device such as a throttling, check, or shuttle valve.

### BACKGROUND OF THE INVENTION

1. Field of Invention

The present invention relates generally to an apparatus and method for varying the flow of a fluid past a device in response to a temperature change. Specifically, the present invention relates to automatically adjusting either the fluid propulsion characteristics of a fluid propulsion device or the throttling of a valve in response to a temperature change. The present invention relies on the thermal expansion of a thermally reactive fluid contained within a reservoir to move a movable portion of the reservoir thereby actuating an adjustable portion of the device.

2. Description of Related Art

In many industries, it is important to move fluids from one location to another. Examples of such fluid movement include air movement for ventilation, water movement for heating, cooling and plumbing, the movement of chemicals for reaction purposes as well as movement of lubricants for lubrication. Often the amount of fluid required at one location or another is not fixed over time but is variable according to surrounding conditions, such as temperature. The control of the movement of a fluid is therefore of great importance to ensure that the required amount of fluid is received at the appropriate location at the appropriate time. Control of a fluid may be by means of a throttling control device or by altering the output of a fluid propulsion device.

Because of the requirements that the amount of fluid at a particular place at a particular time are variable, what is needed is a system of controlling the flow of the fluid dependant upon specific criteria. Specifically, what is needed is a method and system for controlling the flow of the fluid based upon variations in a temperature source. This temperature source could be the fluid itself, an external temperature source or a combination of the two.

Current control systems that control the flow of a fluid based upon a sensed temperature tend to rely on sensors, logic circuits and actuators. Sensors for use in such a system may include electronic sensors, mechanical bulb type sensors or bimetallic strips. The logic circuits, which may range from simple such as completing a circuit to engage an actuator, to complex microcomputers and electronic systems, process the information received from the sensors and provide an output signal to the actuator to cause a corresponding change in the flow of the fluid based upon the information sensed by the sensors.

Systems involving all of these components tend to be expensive and complex. In addition, such systems require a power source to power the actuator and therefore may require complex connection systems to supply the necessary power to the device. This is especially true in the case where the actuator is located on a moving or rotating element of the device. Because of this, the cost involved with implementing such a control system may be greater than the cost of any lost energy and therefore use of control systems to maximize the efficiency may not receive as widespread use as is desirable.

In the art, methods of determining the output characteristics of a fluid flow device are well known. In the case of throttling control, the actuation may involve opening or closing a control valve. In the case of changing the output of a fluid propulsion device, the actuation may comprise changing the speed of the fluid propulsion device or changing the flow rate characteristics of the device. Changing flow rate characteristics may involve changing the swept volume of the blades or vanes included in the device or adding or removing flow limitors such as external vanes or louvers. Changing the swept volume of the blades or vanes may further be accomplished by changing the pitch, length or airfoil section of the blades or vanes. Many of these methods however require that the fluid flow through the device be stopped while the flow rate characteristics of the device are altered.

Airfoil pitch adjusting devices are well known and have been used in airplane and helicopter propellers as well as large industrial fans. However, such pitch adjusting apparatuses still rely on a power source for the actuator and an external controller to determine the desired pitch based on input from a sensor or a user.

The thermal expansion of a helical metal rod surrounding a fan blade shaft has been used to impart rotation to the fan blade shaft when the rod expands in accordance with the coefficient of thermal expansion of the rod as disclosed in U.S. Pat. No. 4,261,174. This helical metal rod arrangement, however, suffers from several problems. The helical rod will tend to expand radially as well as longitudinally in response to a thermal expansion. This radial expansion is a loss of useful expansion to the apparatus. Such a radial expansion must therefore be opposed by constraining the helical coils of the rod with a restraining force so as to ensure that all lengthwise expansion in the rod tends to result in a lengthwise expansion of the coil as opposed to a radial expansion of the coil. Such a force adds frictional losses to the system and serves to further reduce its effectiveness.

### SUMMARY OF THE INVENTION

In accordance with one aspect of the invention there is provided a method of controlling the flow of a fluid past a device having a flow adjusting device. The method involves transmitting a temperature to a thermally reactive material having a coefficient of thermal expansion which produces a volume change in the thermally reactive material in response to a change in the temperature, the thermally reactive material being enclosed within a container having a movable portion which is moved in response to the volume change of the thermally reactive material, and applying the movement of the movable portion to actuate the flow adjusting device.

An increase in the temperature may cause a corresponding increase in the flow rate of the fluid. An increase in the temperature may cause a corresponding decrease in the flow rate of the fluid. The apparatus may be adapted to be capable of either increasing or decreasing the flow rate of the fluid in response to an increase in the temperature.

The temperature transmitted to the thermally reactive material may be the temperature of the fluid. The temperature transmitted to the thermally reactive material may be an external temperature. The temperature transmitted to the thermally reactive material may be an average of an external temperature and the temperature of the fluid. The apparatus may be configured to alternately receive the transmitted temperature from the fluid and an external temperature.

The flow adjusting device may include a throttle for throttling the flow of the fluid. The flow adjusting device may include a pitch controller for controlling the pitch of a vane of a fluid propulsion device. The flow adjusting device may include a vane length controller for controlling the length of a vane of a fluid propulsion device. The flow adjusting device may include a means for varying the swept volume of a pump.

In accordance with another embodiment of the invention, there is provided an apparatus for controlling the flow of a fluid past a flow controller having a flow adjusting device. The apparatus comprises a reservoir housing a thermally reactive material having a coefficient of thermal expansion to cause a constant phase volume change in said thermally reactive material in response to a change in temperature, said reservoir being adapted to transmit a temperature to said thermally reactive material, a movable portion associated with said thermally reactive material wherein said volume change of said thermally reactive material causes a corresponding movement of said movable portion, and wherein said movable portion actuates said flow adjusting device to vary said flow of said fluid in response to movement of said movable portion.

The reservoir may be positioned adjacent to the fluid and the temperature transmitted to the thermally reactive material may be the temperature of the fluid. The reservoir may be positioned external to the fluid flow and the temperature transmitted to the thermally reactive material may be an external temperature. The reservoir may include a portion positioned adjacent to the fluid and a portion positioned external to the fluid flow whereby the temperature transmitted to the thermally reactive material may be the temperature of the fluid or an external temperature.

The flow controller may comprise a fluid propulsion device. The fluid propulsion device may further include at least one vane having a pitch, wherein each of the vanes further includes a shaft having an axis. The flow adjusting device may comprise a pitch adjusting device for adjusting the pitch of the vanes about their axis. The pitch adjusting device may comprise a movable portion being operable to engage a portion of the vane shaft so as to rotate the vane shaft thereby changing the pitch of the vane in response to movement of the movable portion. The movable portion may be integral with the vane shaft. An increase in the temperature of the thermally reactive substance may cause the movable portion to increase the pitch of the vanes. An increase in the temperature of the thermally reactive substance may cause the movable portion to decrease the pitch of the vanes.

The fluid propulsion device may further include a hub, wherein the pitch adjusting device rotatably connects the vane to the hub. The reservoir may circumferentially surround the vane shafts. The reservoir may be positioned within the hub. The fluid propulsion device may further include a stator, wherein the pitch adjusting device rotatably connects vanes to the stator.

The fluid propulsion device may include vanes having adjustable lengths. The fluid propulsion device may include an impeller comprised of a pair of spaced apart ring shaped plates containing vanes therebetween wherein the distance between the plates may be adjusted thereby varying the length of the vanes.

The fluid propulsion device may comprise a fan. The fluid propulsion device may comprise a pump. The fluid propulsion device may comprise a compressor. The fluid propulsion device may comprise a turbine.

The fluid propulsion device may comprise a reciprocating piston pump. The reciprocating piston pump may further include a crank arm having an adjustable offset length driving a connecting rod and pump piston. The crank arm may comprise a journal bearing having an outer surface operable to engage a corresponding surface of the crank arm, wherein the journal bearing is comprised of a hollow body containing a thermally reactive material, a piston and a shaft, wherein the thermally reactive material is in communication with the piston wherein the piston is in communication with the shaft wherein the shaft is offset from the center of the journal bearing.

An increase in the temperature of the thermally reactive material may cause the piston to increase the offset of the shaft from the center of the journal bearing thereby increasing the stroke of the reciprocating piston pump. An increase in the temperature of the thermally reactive material may cause the piston to decrease the offset of the shaft from the center of the journal bearing thereby decreasing the stroke of the reciprocating piston pump. The connecting rod may further include an annular ring surrounding the journal bearing operable to transmit an external temperature to the hollow body. The pump piston may further include a one way valve such that fluid may be pumped past the crank arm thereby transmitting the temperature of the fluid to the hollow body.

The flow controller may comprise a flow regulator. The reservoir may be positioned external to the flow of the fluid. The reservoir may be positioned in the flow of the fluid. The reservoir may include a portion positioned in the flow of the fluid and a portion external to the flow of the fluid.

The flow regulator may comprise a valve wherein the flow adjusting device comprises a plunger operable to vary a distance between the plunger and a cooperating valve seat. An increase in the temperature of the thermally reactive substance may cause the plunger to move towards the valve seat. An increase in the temperature of the thermally reactive substance may cause the plunger to move away from the valve seat.

The flow regulator may include first and second restrictor plates each restrictor plate having at least one aperture wherein the apertures of the first and second restrictor plates may be adjustably aligned. The first and second restrictor plates may be substantially circular and rotatable with respect to each other so as to enable the apertures of the first and second restrictor plates to be rotatably adjustably aligned. An increase in the temperature of the thermally reactive substance may cause the apertures of the first and second restrictor plates to become more aligned. An increase in the temperature of said thermally reactive substance causes said apertures of said first and second restrictor plates to become less aligned.

The flow regulator may comprise a check valve further comprising an enlarged chamber having a first and second openings in opposite ends of said enlarged chamber containing a body operable to alternately block either one of the first or second openings when the direction of fluid flow through the check valve is reversed thereby releasing a volume of fluid past the check valve while the body is moving from one opening to the other.

The chamber wall may include the reservoir and movable portion and may be operable to change the length of the chamber in response to a change in the temperature of the thermally reactive material. An increase in the temperature of the thermally reactive material may cause an increase in the length of the chamber thereby increasing the amount of fluid released past the check valve when the direction of fluid flow through the check valve is reversed. An increase in the temperature of the thermally reactive material may cause a decrease in the length of the chamber thereby decreasing the amount of fluid released past the check valve when the direction of fluid flow through the check valve is reversed.

The body may comprise two hollow hemispheres connected by a neck portion and containing the thermally reactive material contained within the chamber. An increase in the temperature of the thermally reactive material may cause an increase in the distance between the two hollow hemispheres of the expandable body thereby decreasing the amount of fluid released past the check valve when the direction of fluid flow through the check valve is reversed. An increase in the temperature of the thermally reactive material may causes a decrease in the distance between the two hollow hemispheres of the expandable body thereby increasing the amount of fluid released past the check valve when the direction of fluid flow through the check valve is reversed.

The flow regulator may comprise a spool valve having a piston comprised of a hollow body having a first and a second spaced apart hollow cylinders connected by an expandable portion. The expandable portion may be operable to increase in length in response to an increase in the temperature of the thermally reactive material. The expandable portion may be operable to decrease in length in response to an increase in the temperature of the thermally reactive material.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a plan view of a fan according to a first embodiment of the present invention.

FIG. 2 is a sectional view through a fan arm of the fan of FIG. 1 taken along line 2-2 of FIG. 1.

FIG. 3 is a sectional view through a fan arm of the fan of FIG. 1 taken along line 3-3 of FIG. 2.

FIG. 4 is a perspective view of a fan according to another embodiment of the present invention.

FIG. 5 is a sectional view through a fan arm of the fan of FIG. 4 taken along line 5-5 of FIG. 4.

FIG. 6 is a sectional view through a fan arm of the fan of FIG. 4 taken along line 64 of FIG. 4.

FIG. 7 is a sectional view through a fan arm of the fan of FIG. 4 taken along line 7-7 of FIGS. 5 and 6.

FIG. 8 is a sectional view through a fan arm of the fan of FIG. 4 taken along line 8-8 of FIGS. 5 and 6.

FIG. 9 is a cross sectional view of a fluid propulsion device impeller according to another embodiment of the present invention.

FIG. 10 is a cross sectional view of a reciprocating piston pump according to another embodiment of the present invention.

FIG. 11 is a cross sectional view of a reciprocating piston pump according to another embodiment of the present invention.

FIG. 12 is a longitudinal sectional view of a throttling valve according to another embodiment of the present invention.

FIG. 13 is a longitudinal sectional view of a throttling valve according to another embodiment of the present invention.

FIG. 14 is a longitudinal sectional view of a throttling valve according to another embodiment of the present invention.

FIG. 15 is a cross sectional view of a throttling valve according to another embodiment of the present invention.

FIG. 16 is a longitudinal sectional view of a check valve according to another embodiment of the present invention.

FIG. 17 is a longitudinal sectional view of a check valve according to another embodiment of the present invention.

FIG. 18 is a longitudinal sectional view of a check valve according to another embodiment of the present invention.

FIG. 19 is a longitudinal sectional view of a spool valve according to another embodiment of the present invention.

FIG. 20 is a longitudinal sectional view of a spool valve according to another embodiment of the present invention.

### DETAILED DESCRIPTION

In accordance with a first embodiment of the invention, there is provided an apparatus for controlling the flow of a fluid past a flow controller having a flow adjusting device. The apparatus comprises a reservoir, a thermally reactive material and a movable portion.

The reservoir comprises a hollow body having a cavity and an opening. The reservoir is operable to contain a thermally reactive material within the cavity. The reservoir may comprise a cylindrical shape. The reservoir may comprise a substantially annular shape. The reservoir may comprise a jacket operable to surround an arm and form a void therebetween wherein the void may contain the thermally reactive material. The opening of the reservoir is adapted to receive a movable portion.

The movable portion may comprise a piston. The movable portion may comprise a body similar in shape to the reservoir operable to contain a thermally reactive material in common with the reservoir.

The thermally reactive material has a coefficient of thermal expansion operable to cause a constant phase volume change in the thermally reactive material in response to a change in temperature. The thermally reactive material has a viscosity. The thermally reactive material may comprise a liquid having a relatively high viscosity such as a grease.

In operation, the reservoir transmits a temperature to the thermally reactive material. The thermally reactive material changes volume in response to the temperature change in accordance with its coefficient of thermal expansion. The volume change of the thermally reactive material causes a corresponding movement of the movable portion. The movable portion actuates the flow adjusting device to vary the flow of the fluid in response to movement of the movable portion. The apparatus may be applied to a variety of fluid flow controlling devices. By reference to the following Figures, exemplary applications of the apparatus to fluid flow controlling devices are described.

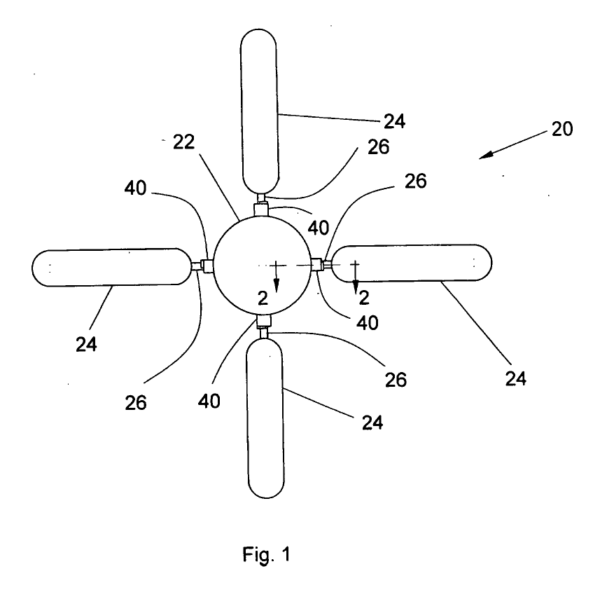

Referring to FIG. 1, a fan incorporating a flow adjusting apparatus according to a first embodiment of the invention is shown generally at 20. The fan 20 includes a hub 22, and a plurality of fan blades 24. The fan blades 24 are rotatably connected to the fan hub by fan blade shafts 26. The fan 20 includes a flow adjusting apparatus shown generally at 40 surrounding the base of each of the fan blades. The fan according to the embodiment shown in FIG. 1 is an axial flow type fan arrangement including fan blades having a fixed length. It will be appreciated that it is possible to incorporate the flow adjusting device of the present invention into other types of fans. For example, the flow adjusting device may be applied to stator blades or vanes as well as centrifugal blades or vanes, in addition to impeller blades as shown in FIG. 1.

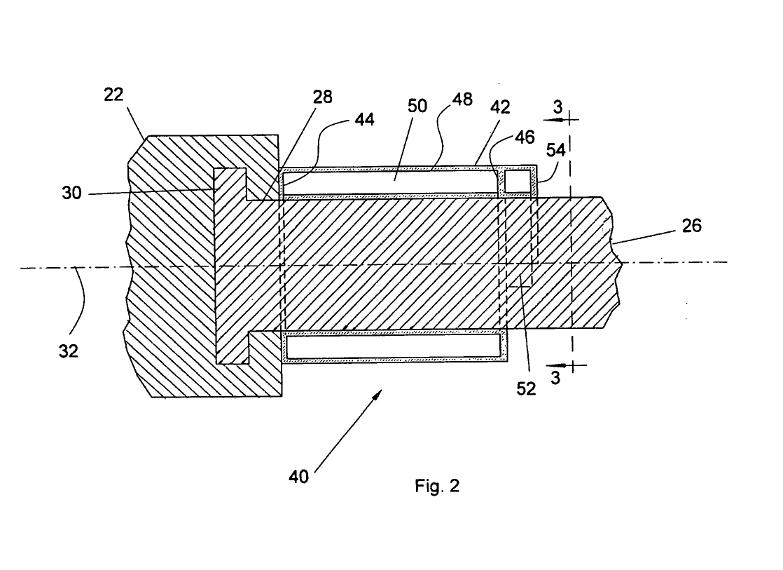

Referring now to FIG. 2, there is shown a sectional view of the fan hub 22, one of the fan blade shafts 26, and flow adjusting apparatus 40. FIG. 2 is a cross-section taken along line 2-2 of FIG. 1. The fan blade shaft has a circular cross-section and is rotatably connected into a corresponding cavity 28 in the fan hub 22. The fan blade shaft includes a flanged portion 30 that is received in a corresponding widened portion of the fan hub cavity 28 so as to retain the fan blade shaft 26 within the cavity 28 while allowing the fan blade shaft to rotate about its axis 32 relative to the fan hub.

The flow adjusting apparatus according to a first embodiment of the present invention is shown generally at 40 and comprises an annular jacket reservoir 42 having proximate and distal ends 44 and 46 respectively. The annular jacket reservoir 42 surrounds the fan blade shaft 26 and defines a chamber 48 which contains a thermally reactive material 50 having a coefficient of thermal expansion. The apparatus further includes an annular piston 52 contained within an annular cylinder 54 located at the distal end 46 of the jacket reservoir 42. The cylinder is in fluidic communication with the annular jacket reservoir such that expansion of the thermally reactive material will displace the piston 52 circumferentially around the fan blade shaft 26. The proximate end 44 of the annular jacket reservoir is fixably attached to the fan hub 22. The piston 52 rotationally engages the fan blade shaft 26 which is rotatable relative to the annular jacket reservoir.

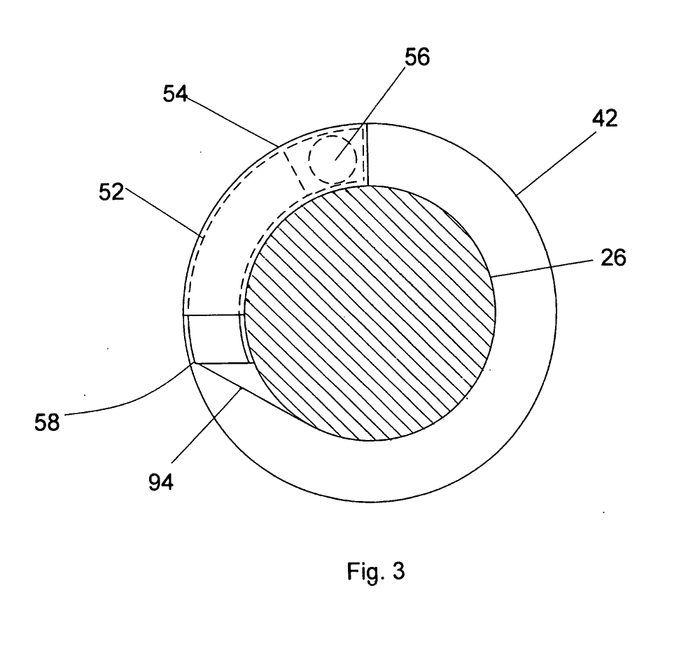

Referring now to FIG. 3, a sectional view of the fan blade and flow adjusting apparatus is shown taken along line 3-3 of FIG. 2. The annular jacket reservoir 42 surrounds the fan blade shaft 26. The annular cylinder 54 is in fluidic communication with the chamber defined by the annular jacket reservoir through orifice 56. Annular piston 52 comprises an arcuate segment adapted to be slidably received within annular cylinder 54. Piston 52 includes a distal end 58 that engages a protrusion 94 on the fan blade shaft 26. Although the annular piston 52 is shown as having a square cross section in FIGS. 2 and 3, it will be appreciated that other cross sectional shapes may be used as well.

In operation, the annular jacket reservoir 42 transmits the temperature of the fluid to the thermally reactive material 50. The thermally reactive material expands or contracts in response to the temperature transmission in accordance with its coefficient of thermal expansion. The expansion of the thermally reactive material causes a volume of the thermally reactive material to be displaced into the annular cylinder 54 through orifice 56 thereby displacing the annular piston 52. It will be appreciated that air loads, springs, elastic media, magnets or other forces may be applied to restore the annular piston 52 to an initial position on contraction of the thermally reactive material 50.

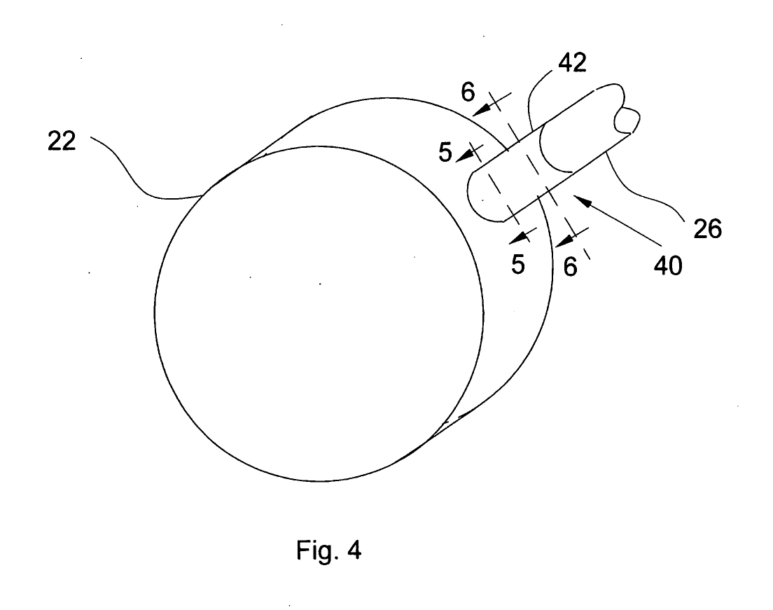

FIG. 4 shows another embodiment of the present invention comprising a fan having fan blades (not shown), fan blade shafts 26 (only one shown) and flow adjusting apparatus 40. According to the embodiment shown in FIG. 4 the flow adjusting apparatus and fan blade shaft 26 are interlocking and the fan blade shaft does not engage the fan hub 22 directly. In this embodiment, the reservoir retaining the thermally reactive material may be incorporated into the fan hub and fan blade shaft 26 rotatably attached to the reservoir.

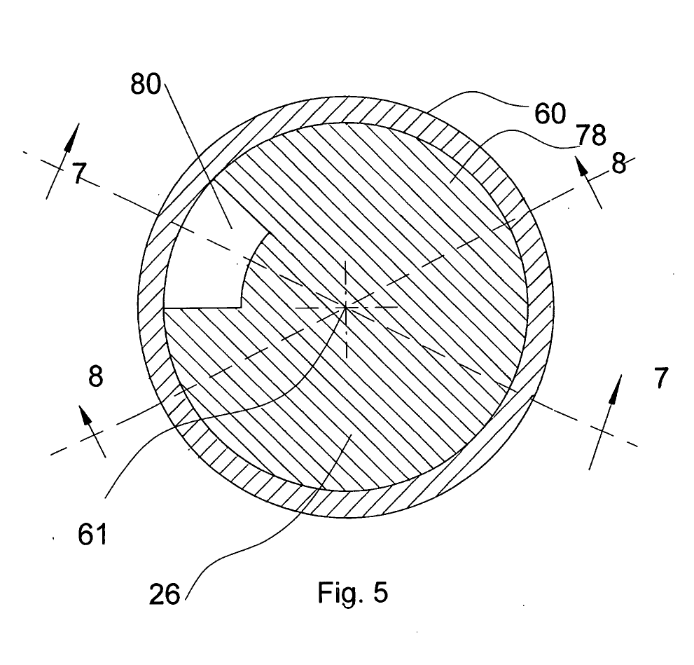

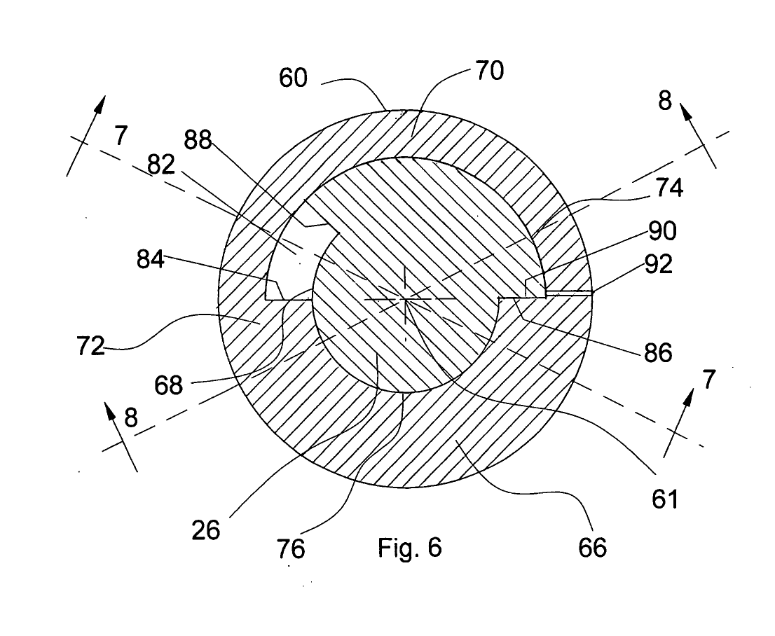

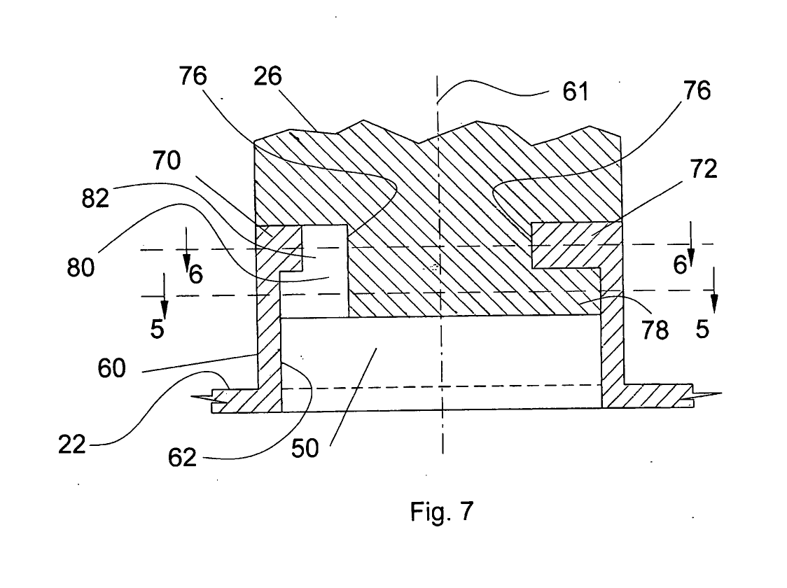

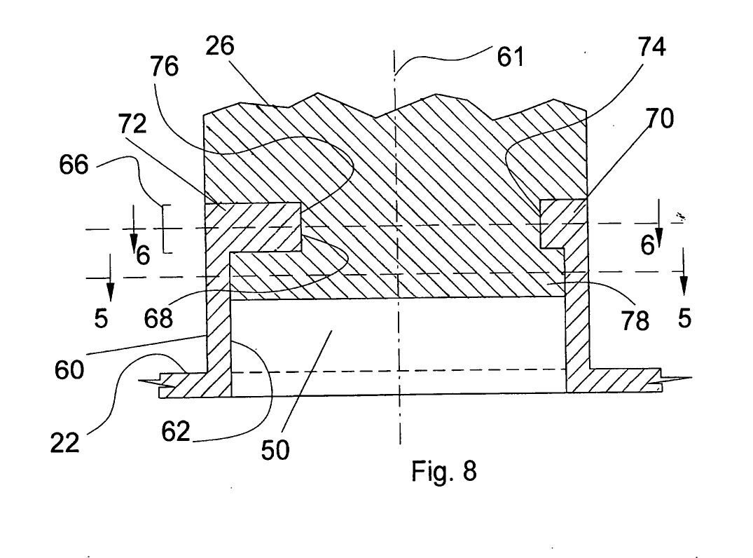

FIGS. 5 to 8 provide detailed sectional views of the embodiment of FIG. 4. FIGS. 7 and 8 are section views taken along the lines 7-7 and 8-8 respectively on FIGS. 5 and 6. Conversely FIGS. 5 and 6 are sectional views taken along the lines 5-5 and 6-6 respectively of FIGS. 7 and 8. As shown in FIGS. 5 to 8, the flow adjusting apparatus comprises cylindrical collar 60 which is operable to surround the base of the fan blade shaft 26 and form a reservoir 62 therein as shown in FIGS. 7 and 8. The reservoir contains the thermally reactive material 50. As best shown in FIG. 8, the collar projects from the fan hub 22 and has a distal end which includes an internal flange 66 operable to be received in a corresponding groove 68 in the fan blade shaft 26. The fan blade shaft 26 is rotatable about axis 61.

Still referring to FIG. 8, the internal flange 66 includes a first portion 70 having a large radius circular opening and a second portion 72 having a smaller radius circular opening. The groove 68 in the fan blade shaft has a first groove portion 74 having a large radius and a second portion 76 having a smaller radius wherein the first and second portions 74 and 76 of the groove 68 correspond with the first and second portions 70 and 72 of the collar internal flange 66 respectively.

The fan blade shaft 26 further has a flange 78 at its end which is received in the reservoir 62. The fan blade flange 78 has a larger radius than the openings in either the first or second portion 70 and 72 of the internal flange 66 of the collar 60. The fan blade shaft 26 is retained within the collar 60 by the internal flange 66 of the collar and the flange 78 of the fan blade shaft.

FIG. 5 shows a sectional view of the fan blade shaft and collar through the fan blade shaft flange as taken along line 5-5 of FIGS. 4, 7 and 8. As shown in FIG. 5, the fan blade shaft flange 78 includes a gap 80 which may receive the thermally reactive material 50 contained in the reservoir 62.

FIG. 6 shows a sectional view of the fan blade shaft and collar through the internal flange 66 of the collar and groove 68 of the fan blade shaft as taken along line 6-6 of FIGS. 4, 7 and 8. The radius of the first portion 70 of the internal flange of the collar matches the radius of the first portion 74 of the groove of the fan blade shaft. Similarly, the radius of the second portion 72 of the internal flange of the collar matches the radius of the second portion 76 of the groove of the fan blade shaft. The internal flange 66 further includes a second wall 86. The groove 68 further includes a second wall 90. The first and second walls 84 and 86 of the internal flange 66 define the boundary between the first 70 and second 72 portions of the internal flange. The first and second walls 88 and 90 of the groove 68 define the boundaries between the first 74 and second 76 portions of the groove.

As shown in FIG. 6, the first portion 74 of the groove comprises a smaller angular proportion of the fan blade shaft 26 than does the first portion 70 of the internal flange of the collar thereby forming an opening 82 between the groove 68 and first portion 74 of the internal flange 66. The opening 82 is further defined by the first wall 84 of the internal flange 66 and the first wall 88 of the groove 68. The opening 82 enables the fan blade shaft 26 to be rotated relative to the collar 60 through an angle defined by the angular difference between the angular proportion of the first portion 70 of the internal flange 66 and the first portion 74 of groove 68. As shown in FIG. 6, the fan blade shaft 26 is rotated such that the opening 82 is fully opened. It will be appreciated that when the opening 82 is not fully opened a similar opening will be formed between the second wall 86 of the internal flange 66 and the second wall 90 of the groove 68. It will further be appreciated that it may be desirable to provide a vent 92 between the opening defined by the second wall 86 of the internal flange 66 and the second wall 90 of the groove 68 so as to prevent an excess pressure or vacuum build up in this opening when the fan blade shaft is rotated relative to the collar.

In operation, the collar 60 and the fan hub 22 transmit the temperature of the fluid to the thermally reactive material 50. The thermally reactive material expands or contracts in response to the temperature transmission in accordance with its coefficient of thermal expansion. The expansion of the thermally reactive material causes a volume of the thermally reactive material to be displaced into the gap 80 and opening 82 thereby pressing the first wall 88 of the groove 68 apart from the first wall 84 of the internal flange 66. The fan blade shaft is thereby rotated relative to the collar until the second walls of the internal flange and the groove 86 and 90 respectively meet.

In the above embodiment, the volume flow rate of a fan is automatically adjusted by changing the pitch of the fan blades. It will be appreciated that the volume flow rate of a fan may be adjusted by numerous other methods such as changing the fan blade length.

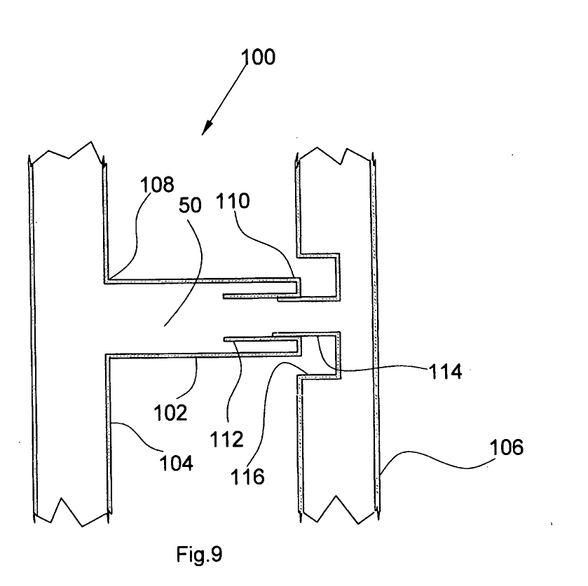

FIG. 9 shows another embodiment of the present invention in which the length of the far blades may be adjusted. As shown in FIG. 9, a fan impeller shown generally at 100 includes fan blades or vanes 102 between first and second spaced apart end plates 104 and 106 respectively. The fan blade 102 comprises an elongated hollow body having first and second ends 108 and 110 and contains the thermally reactive material 50. The first end 108 of the fan blade is fixably attached to the first end plate 104. The first end plate may also be hollow and contain the thermally reactive material 50 in fluidic communication with the thermally reactive material 50 in the fan blade. The second end 110 of the fan blade contains a first sleeve 112 which is operable to slidably receive a corresponding second sleeve 114 attached to the second end plate 106. The second sleeve 114 is located within a cavity 116 in the second end plate 106 such that at least a portion of the second end 110 of the fan blade 102 is located within the cavity 116. It will be appreciated that the second sleeve may comprise a piston being received within the first sleeve wherein the piston is fixably attached to the second end plate 106.

In operation, the fan blade 102, and first and second end plates 104 and 106 transmit the temperature of the fluid to the thermally reactive material 50. The thermally reactive material expands or contracts in response to the temperature transmission in accordance with its coefficient of thermal expansion. The expansion of the thermally reactive material causes the second sleeve 114 to be slidably displaced relative to the first sleeve 112 in accordance with the volume change of the thermally reactive material 50. The movement of the second sleeve 114 relative to the first sleeve 112 causes the distance between the first and second end plates 104 and 106 to be varied. The change in the distance between the first and second end plates 104 and 106 causes the amount of the second end 110 that is covered by the cavity 116 to be changed thereby changing the swept volume capacity of the fan. The fan may also include a spring or other means for causing the distance between the first and second end plate 104 and 106 to be decreased upon a contraction of the thermally reactive material 50.

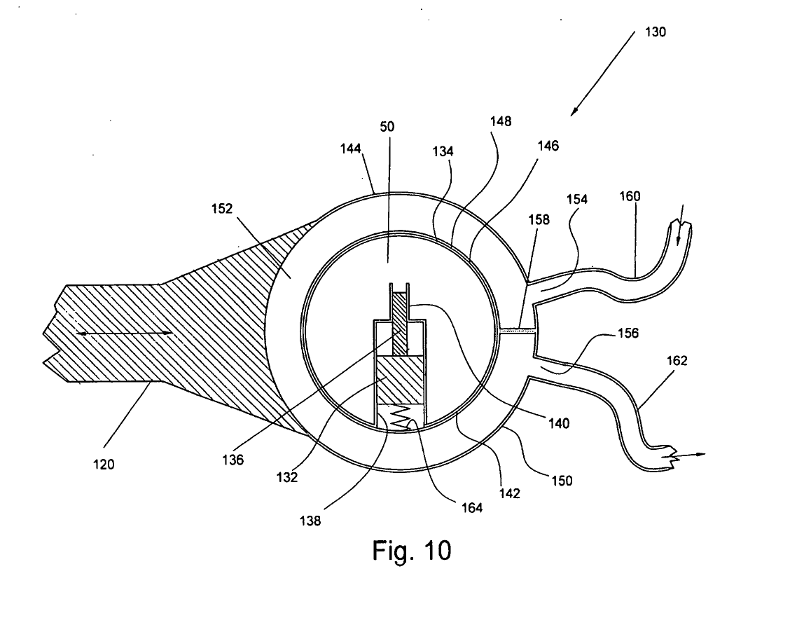

Turning now to FIG. 10, another embodiment of the present invention is shown in which the fluid propulsion device may comprise a reciprocating piston pump having a piston (not shown in FIG. 10), a connecting rod 120 and a crank shaft assembly shown generally at 130. The crank shaft assembly may comprise a square shaft 132, a hollow body 134 containing a thermally reactive material 50 and a piston 136. The square shaft 132 is received within the hollow body 134 within a slot 138 portion of the hollow body. The piston 136 is slidably received within a cylindrical portion 140 of the hollow body 134. The hollow body 134 comprises a substantially cylindrical body having an outer journal surface 142.

The connecting rod 120 includes an end bearing 144. The end bearing 144 comprises an inner wall 146 having inner journal surface 148 and an outer wall 150 defining a substantially annular chamber 152. The substantially annular chamber includes an inlet port 154, an outlet port 156 and a partition 158. Inlet and outlet ports 154 and 156 may be connected to supply and drain hoses 160 and 162 respectively completing a circuit of a fluid flowable through the annular chamber between the supply and drain hoses 160 and 162.

The rotation of the square shaft 132 imparts a rotation to the hollow body 134 about the center of the square shaft which is offset from the center of the hollow body. As the hollow body eccentrically rotates about the square shaft 132, the outer journal surface 142 of the hollow body rotates relative to the inner journal surface 148 of the end bearing 144 thereby imparting the eccentric motion of the hollow body to the end bearing without the corresponding rotation. The eccentric rotary motion of the end bearing causes a corresponding linear cyclical motion in the piston through the connecting rod 120 having a stroke length defined by double the distance between the center of the hollow body 134 and the center of the square shaft 132.

In operation, a fluid is passed through the annular chamber 152 between the inlet port 154 and the outlet port 156 thereby imparting the temperature of the fluid through the hollow body 134 to the thermally reactive material 50. The thermally reactive material expands or contracts in response to the temperature transmission in accordance with its coefficient of thermal expansion. The expansion of the thermally reactive material causes the piston 136 to be displaced within the cylinder portion 140 of the hollow body. The movement of the piston 136 causes the offset between the center of the hollow body 134 and the center of the square shaft 132 to be changed thereby changing the stroke length of the pump. The crank shaft assembly may also include a spring 164 or other similar reset means to urge the piston 136 into the cylinder 140 upon a contraction of the thermally reactive material 50.

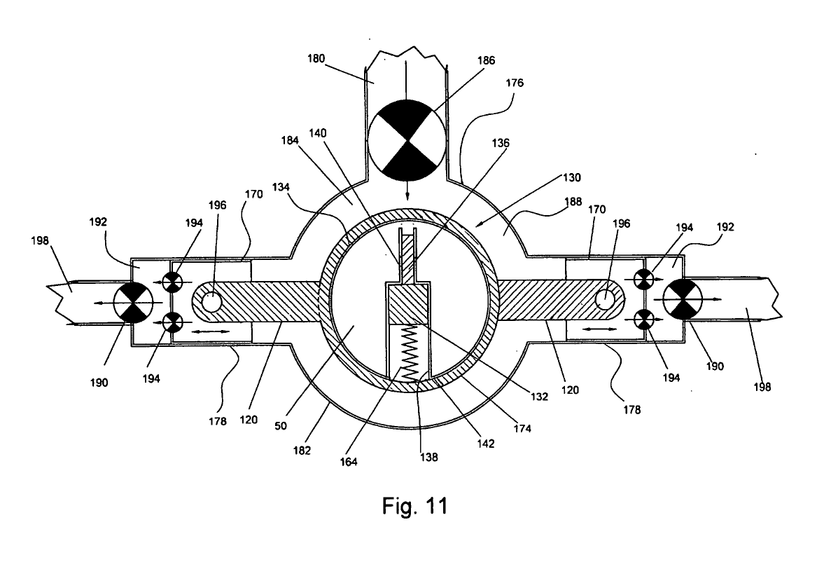

Turning now to FIG. 11, another embodiment of the present invention is shown. As shown in FIG. 11, the present invention may comprise a reciprocating piston pump which includes a plurality of displacement pistons 170. The piston pump includes a plurality of connecting rods 120, each connected to its own end bearing 174, and a cylinder block 176. The end bearings contain a crank shaft assembly as shown generally at 130 comprising a square shaft 132, a hollow body 134 containing a thermally reactive material 50 and a piston 136. The square shaft 132 is received within the hollow body 134 within a slot 138 portion of the hollow body. The piston 136 is slidably received with a cylinder portion 140 of the hollow body 134. The hollow body 134 comprises a substantially cylindrical shaped body having an outer journal surface 142.

The cylinder block 176 comprises a body having a plurality of cylinders 178, an inlet port 180 and a central cylindrical portion 182 having a central cavity 184. The end bearings 174 are contained with the central cavity 184. The inlet port includes a one-way inlet valve 186 operable to permit the introduction of a fluid 188 into the central cavity 184 and prevent the removal of the fluid through the one-way inlet valve. Each cylinder 178 comprises a hollow cylindrical body having a distal end.

The displacement pistons 170 are slidably and sealably received in the cylinders 178 and define a pumping chamber 192 between the displacement piston 170 and the distal end of the cylinder 178. The displacement pistons 170 may include piston one-way valves 194 operable to permit the fluid to pass from the cylinder to the pumping chamber 192 but not from the pumping chamber back into the cylinder. The cylinders also include one-way outlet valves 190 at their distal ends operable to release the fluid from the pumping chamber 192 into an outlet port 198. The displacement pistons are connected to connecting rods 120 by pivots 196. The connecting rods, in turn, extend from the end bearings 174.

In operation, the rotation of the square shaft 132 imparts a rotation to the hollow body 134 about the center of the square shaft which is offset from the center of the hollow body. As the hollow body eccentrically rotates the outer journal surface 142 of the hollow body rotates relative to the inner journal surface of the end bearings 174. The rotation of the hollow body imparts eccentric motion to the end bearings about the center of the square shaft of the piston. The eccentric motion of the end bearing causes a corresponding reciprocating motion having a stroke length defined by twice the length between the center of the hollow body 134 and the center of the square shaft 132.

As the displacement pistons 170 move towards the central cylindrical portion 182, piston one-way valves 194 permit the fluid to pass from the cylinder into the pumping chambers 192. When the pistons move away from the central cylindrical portion 182, the one-way outlet valves permit the fluid to pass out of the pumping chamber to the external outlets 198. In addition, when the displacement pistons 170 move away from the central cylindrical portion 182, the one-way inlet valve 186 permits the fluid to enter the central cavity 184 and therefore the cylinders 178. In this way the pumping movement of the displacement pistons 170 causes the fluid to pass through the cylinder block 176.

The end bearings 174 and the hollow body 134 cause the temperature of the fluid to be transmitted to the thermally reactive material 50. The thermally reactive material expands in accordance with its coefficient of thermal expansion thereby displacing the piston 136 within the cylinder portion 140 of the hollow body 134 and changing the distance between the center of the hollow body 134 and the center of the square shaft 132. In this way the present invention according to the embodiment shown in FIG. 11 uses the temperature of the pumped fluid to vary the volume output of the reciprocating piston pump. It will be appreciated that although the reciprocating piston pump shown in FIG. 11 increases the stroke length and therefore the pumped volume in response to an increase in the temperature of the fluid, the reciprocating piston pump may also be arranged to decrease the stroke length and therefore the pumped volume in response to an increase in the temperature of the fluid.

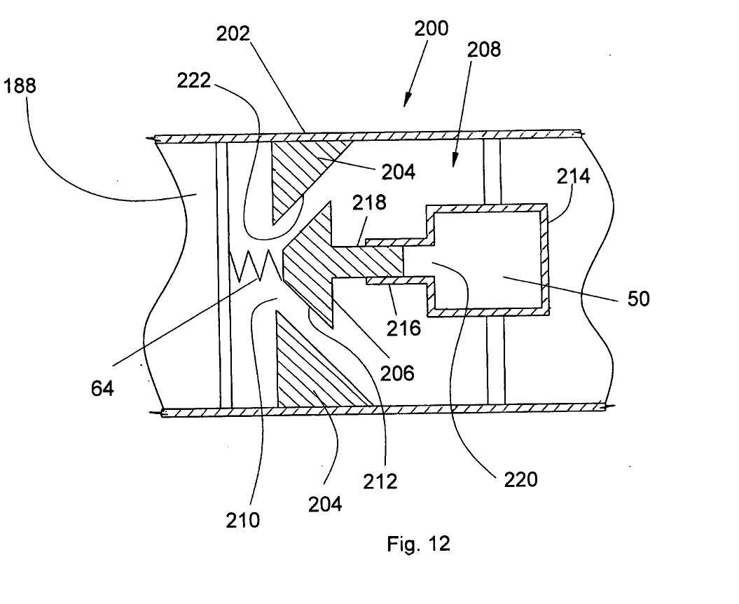

FIGS. 12 to 15 show further embodiments of the present invention wherein the temperature change of a thermally reactive material is used to control a throttling valve. Referring now to FIG. 12, a further embodiment of the present invention is shown comprising a flow controlling valve indicated generally at 200 in a pipe 202 passing a fluid 188. The flow controlling valve 200 comprises a valve seat 204, a plunger 206, and a flow controlling apparatus shown generally at 208. The valve seat 204 comprises a body which occludes the pipe and includes an opening 210 defined by a tapered aperture 222 in the valve seat. The plunger 206 comprises a body having a tapered end 212 operable to sealably engage the tapered aperture 222 of the valve seat. The volume of fluid permitted to flow past the flow controlling valve 200 may be varied by changing the distance between the tapered aperture 222 and the tapered end 212.

The flow controlling apparatus 208 comprises a reservoir 214, a cylinder portion 216 and a piston 218 slidably and sealably received in the cylinder portion 216. The reservoir comprises a hollow body containing a thermally reactive material 50. The cylinder 216 comprises a hollow body operable to receive the piston 218 wherein the cylinder cavity 220 is in fluidic communication with the thermally reactive material 50 contained in the reservoir 214. Piston 218 is connected to plunger 206.

In operation, the reservoir 214 transmits the temperature of the fluid 188 to the thermally reactive material 50. The thermally reactive material expands or contracts in response to the temperature transmission in accordance with its coefficient of thermal expansion. The expansion of the thermally reactive material 50 will cause the piston 218 to be displaced in the cylinder 216 thereby moving the plunger 206 relative to the valve seat 204. The movement of the plunger varies the distance between the tapered end 212 and the tapered end 212 thereby varying the volume of fluid permitted to flow past the flow controlling valve 200. It will be appreciated that although the throttling valve as shown in FIG. 12 decreases the volume of fluid permitted to flow past the fluid controlling valve in response to an increase in the temperature of the fluid, the throttling valve may also be arranged to increase the volume of fluid permitted to flow past the fluid controlling valve in response to an increase in the temperature of the fluid. The present embodiment may also include a spring 64 or other similar reset means to urge the piston 218 into the cylinder 216 upon a contraction of the thermally reactive material 50.

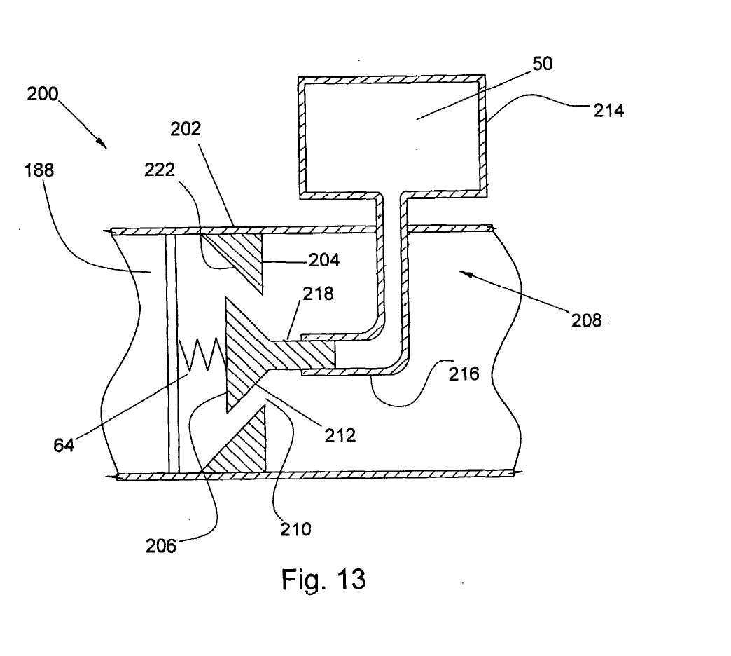

Referring now to FIG. 13, another embodiment of the present invention is shown in which the reservoir 214 is positioned external to the pipe 202. In this embodiment the flow controlling apparatus 208 will vary the volume of fluid 188 permitted to flow past the fluid controlling valve in response to a change in a temperature external to the pipe 202. In addition, in the embodiment shown in FIG. 13, the throttling valve will increase the flow of the fluid in response to an increase in the temperature of the thermally reactive material 50 which is the opposite arrangement to the previous embodiment of FIG. 12.

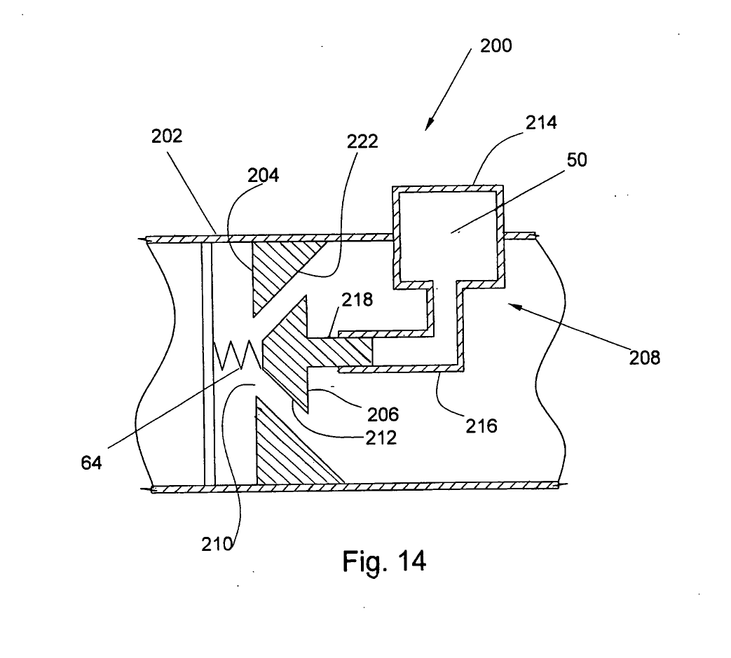

Referring now to FIG. 14, another embodiment of the present invention is shown in which a portion of the reservoir 214 is positioned within the pipe 202 and a portion of the reservoir 214 is positioned external to the pipe. In this embodiment, the flow controlling apparatus 208 will vary the volume of fluid permitted to flow past the fluid controlling valve in response to a change in either the temperature of the fluid or a change in a temperature external to the pipe 202.

The above embodiments shown in FIGS. 12, 13 and 14 describe embodiments in which the apparatus may either increase or decrease the flow rate of the fluid in response to an increase in temperature. In addition, the embodiments shown in FIGS. 12, 13 and 14 describe embodiments in which the apparatus may be adapted to receive the temperature from the fluid, an external temperature or a combination of the temperature of the fluid and an external temperature. The embodiments described above and shown in FIGS. 12, 13 and 14 include the variables of the throttling direction (opening or closing on an increase in temperature) and reservoir location. It will be appreciated these two variables may be combined into six embodiments of which three are currently shown and described in FIGS. 12, 13 and 14. It will further be appreciated that the apparatus may be arranged so as to enable the apparatus to be adapted to alternate between two or more embodiments of the aforementioned six embodiments.

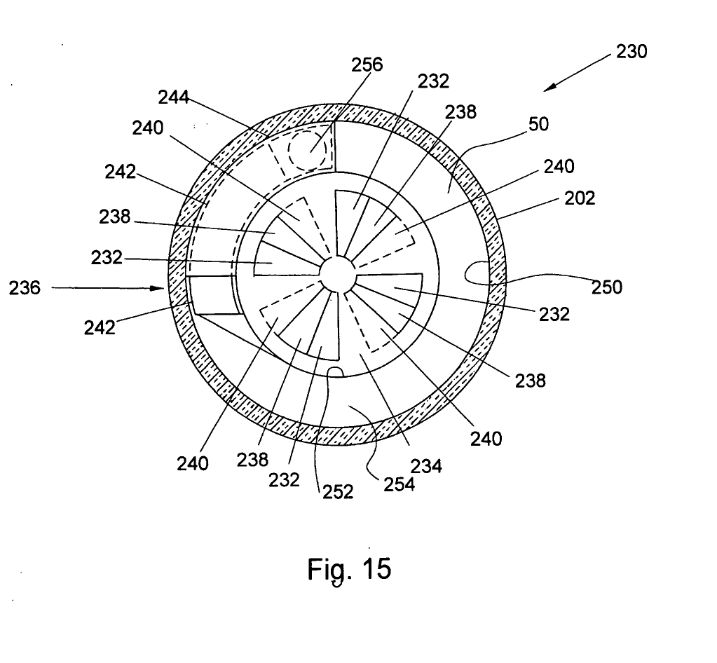

FIG. 15 shows another throttling valve 230 according to another embodiment of the present invention in a pipe 202. The orifice throttling valve 230 comprises first throttling plate 232 and second throttling plate 234 and a flow controlling apparatus shown generally at 236. The first throttle plate 232 is fixably attached to the inner wall 252 of an annular reservoir jacket 254 and includes a first set of apertures 240. The first throttling plate may also be fixably attached to an inner wall 250 of the pipe. The second throttle plate 234 is rotably attached to the first throttle plate 232 and includes a second set of apertures 238. The second throttle plate may be rotated so as to align the first set of apertures 240 with the second set of apertures 238 thereby permitting the flow of the fluid in the pipe to pass the throttling valve. The volume of fluid permitted to flow past the orifice throttling valve 230 may be varied by adjusting the degree of alignment between the first set of apertures 240 and the second set of apertures 238.

The flow controlling apparatus comprises a piston 242, a cylinder 244 and a reservoir 254. The reservoir comprises an annular jacket containing a thermally reactive material 50 and is in communication with the cylinder 244 through an orifice 256. The cylinder is further fixably attached to the inner wall 250 of the pipe 202. The piston 242 is slidably and sealably received within the cylinder 244 and fixably connected to the second throttling plate 234. The reservoir may comprise an annular jacket which surrounds the pipe 202 or is received within the pipe so as to transmit the temperature of the fluid to the thermally reactive material 50.

As shown in FIG. 15, the throttling valve includes a reservoir that is located internal to the pipe and thermally insulated from the exterior of the pipe. The reservoir may also located external to the pipe so as to have an external temperature transmitted to the thermally reactive material 50. The reservoir may also be located so that a part of the reservoir is internal to the pipe and a part of the reservoir is external to the pipe. In this latter arrangement, the flow controlling apparatus will vary the volume of fluid permitted to flow past the apparatus in response to a change in either the temperature of the fluid or a change in a temperature external to the pipe.

In operation, the annular reservoir jacket 254 transmits the temperature of the fluid to the thermally reactive material 50. The thermally reactive material expands or contracts in response to the temperature transmission in accordance with its coefficient of thermal expansion. The expansion of the thermally reactive material 50 will cause the piston 242 to be displaced in the cylinder 244 thereby moving the second throttling plate 234 relative to the first throttling plate 232. The movement of the second throttling plate 234 relative to the first throttling plate 232 varies the degree of alignment between the first and second sets of apertures 240 and 238, respectively thereby varying the volume of fluid permitted to flow past the flow controlling valve 230. The throttling valve may also include a spring or other means for causing the piston to be displaced into the cylinder thereby resetting the throttling plates 234 and 232 back to an initial position.

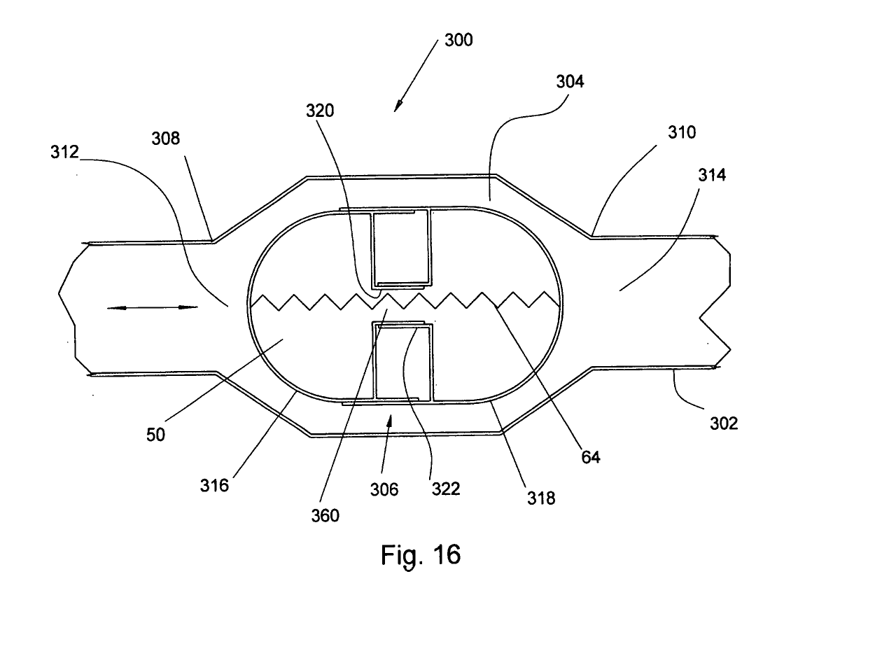

FIGS. 16 to 18 show further embodiments of the present invention wherein the temperature change of a thermally reactive material is used to control the amount of fluid released past a throttling valve with each successive reversal of direction of the fluid through the valve.

Referring now to FIG. 16, an embodiment of the present invention is shown comprising a check valve 300 in a pipe 302. The check valve 300 comprises a chamber 304 of the pipe 302, and a body shown generally at 306. The chamber 304 comprises an enlarged portion of the pipe 302 having first and second ends 308 and 310, respectively. The first and second ends each include an opening 312 and 314, respectively, in fluidic communication with the pipe 302.

The body 306 comprises first hemisphere 316 and second hemisphere 318 of a ball having first and second sleeves 320 and 322, respectively, extending into the interior of each hemisphere. The first sleeve 320 of the first hemisphere is slidably and sealably received within the second sleeve 322 of the second hemisphere. The first and second hemispheres comprise hollow bodies containing a thermally reactive material 50. The first and second sleeves comprise hollow cylindrical shapes having first ends in fluidic communication with their associated hemisphere and second open ends. The first and second sleeves 320 and 322 respectively form a passage between the first and second hemispheres 316 and 318.

The flow of fluid in the check valve shown generally may be reversed and the check valve will serve to prevent a continuing flow of fluid in either direction. Each time the flow of the fluid is reversed, the body 306 will move from one opening to the other while allowing an amount of the fluid to flow past the body before the body occludes the opposite opening. The volume of the fluid that is permitted to pass the body is determined based on the length of the body.

In operation, the body 306 transmits the temperature of the fluid to the thermally reactive material 50. The thermally reactive material expands or contracts in response to the temperature transmission in accordance with its coefficient of thermal expansion. Contraction of the body is assisted by spring 64. The expansion of the thermally reactive material 50 will cause the first and second sleeves to be slidably displaced relative to each other thereby increasing the length of the body. The amount of fluid permitted to pass the check valve with each successive change in flow direction of the fluid will therefore be decreased as the temperature of the fluid increases. Spring 64 will decrease the length of the body 306 upon cooling of the thermally reactive material 50.

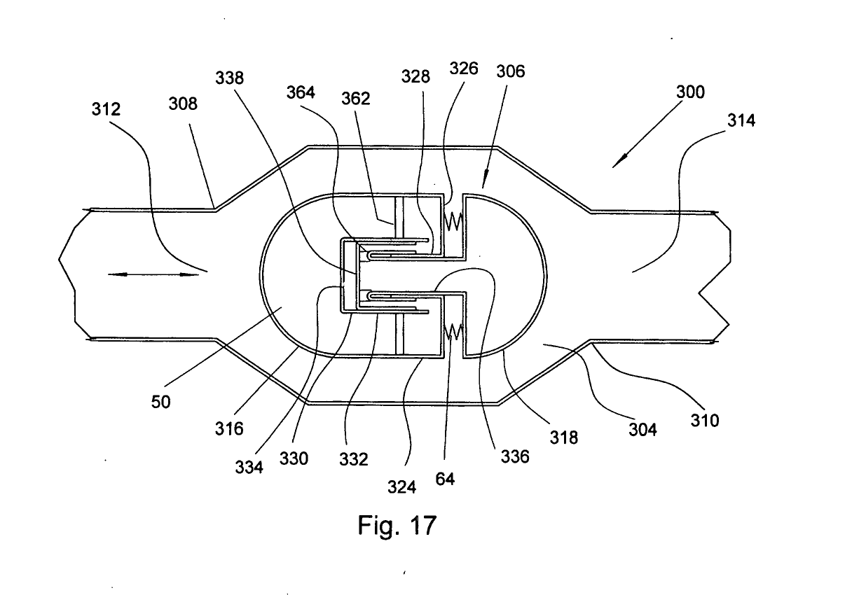

Referring now to FIG. 17, another embodiment of the present invention is shown in which the body 306 is arranged to decrease in length in response to an increase in temperature of the fluid. As the body decreases in length, the amount of fluid permitted to pass the body with each successive change in the flow of direction of the fluid will accordingly increase as the temperature of the fluid increases.

The body 306 comprises first and second hemispheres 316 and 318, respectively. The first hemisphere further includes an outer cylindrical portion 324 having a radius equal to the first hemisphere extending perpendicularly away from the first hemisphere 316. The outer cylindrical portion includes an end wall 326 formed with a central bore defined by an internal sleeve 328. Internal sleeve 328 is coaxial with the outer cylindrical portion 324. The first hemisphere 316 further includes an internal cup 330 formed of an inner cylindrical wall 332 coaxial with the outer cylindrical portion and a bottom 334. The interior of internal cup 330 opens in the direction of the second hemisphere. The second hemisphere includes a protruding sleeve 336 extending perpendicularly away from the base of the second hemisphere towards the first hemisphere. The second hemisphere further includes a nested cup 338 that is received within the internal cup 330 of the first hemisphere. The distance from the first hemisphere 316 to the inner cup 330 is fixed by struts 362. The distance from the second hemisphere 318 to the nested cup 338 is fixed by struts 364.

In operation, a temperature from the fluid is transmitted to the thermally reactive material 50 contained within the body which will accordingly expand in accordance with its coefficient of thermal expansion. The expansion of the thermally reactive material will cause the end 326 of the first hemisphere 316 and the nested cup 338 of the second hemisphere 318 to be pushed apart which will in turn cause the first and second hemispheres to be pulled closer together thereby decreasing the length of the body. The amount of fluid permitted to pass the body with each successive change in flow direction of the fluid will therefore be increased as the temperature of the fluid increases. The springs 64 will expand the length of the body 306 upon the thermally reactive material 50 being cooled.

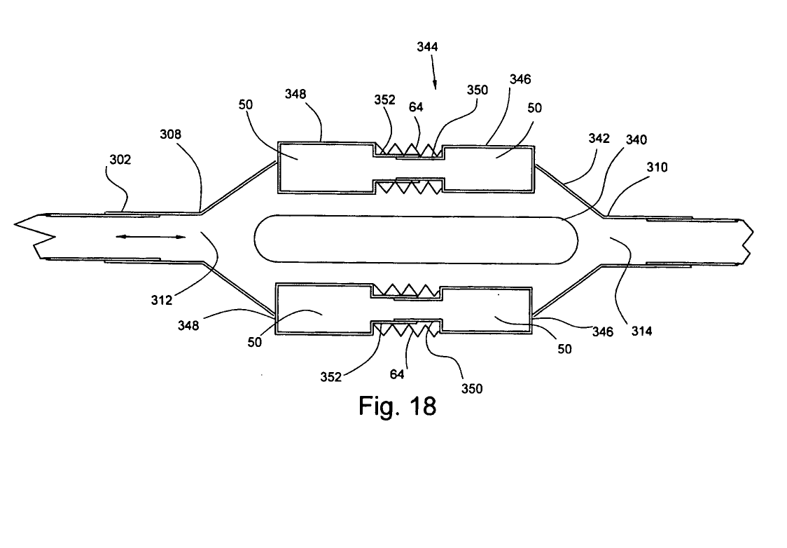

Referring now to FIG. 18, another embodiment according to the present invention is shown comprising a check valve wherein the length of the chamber is changable in response to a change in temperature. The check valve as shown in FIG. 18 includes a body 340, and a chamber 342 having first and second ends 308 and 310, respectively.

The chamber further includes a length adjusting portion shown generally at 344. The length adjusting portion comprises first and second annular hollow portions 346 and 348, respectively having first and second sleeves 350 and 352 respectively extending away from the first and second hollow portions. The first sleeve 350 of the first hollow portion is slidably and sealably received within the second sleeve 352 of the second hollow portion. The first and second hollow portions comprise hollow bodies containing a thermally reactive material 50. The first and second sleeves comprise hollow cylindrical shapes having open ends and being in fluidic communication with their associated hollow portions. It will be appreciated that although the chamber is shown in FIG. 18 to be operable to increase in length in response to a temperature increase, it may also be possible to configure the chamber to decrease in length in response to a temperature change.

In operation, a temperature is transmitted from the fluid or from the exterior to the thermally reactive material 50. The thermally reactive material expands in response to the temperature transmission in accordance with its coefficient of thermal expansion. The expansion of the thermally reactive material 50 will cause first sleeve 350 and second sleeve 352 to be slidably displaced relative to each other thereby increasing the length of the chamber. The amount of fluid permitted to pass the check valve with each successive change in flow direction of the fluid will therefore be increased as the temperature of the fluid increases. Springs 64 will decrease the length of the chamber 342 in response to a decrease in the temperature of the thermally reactive material 50.

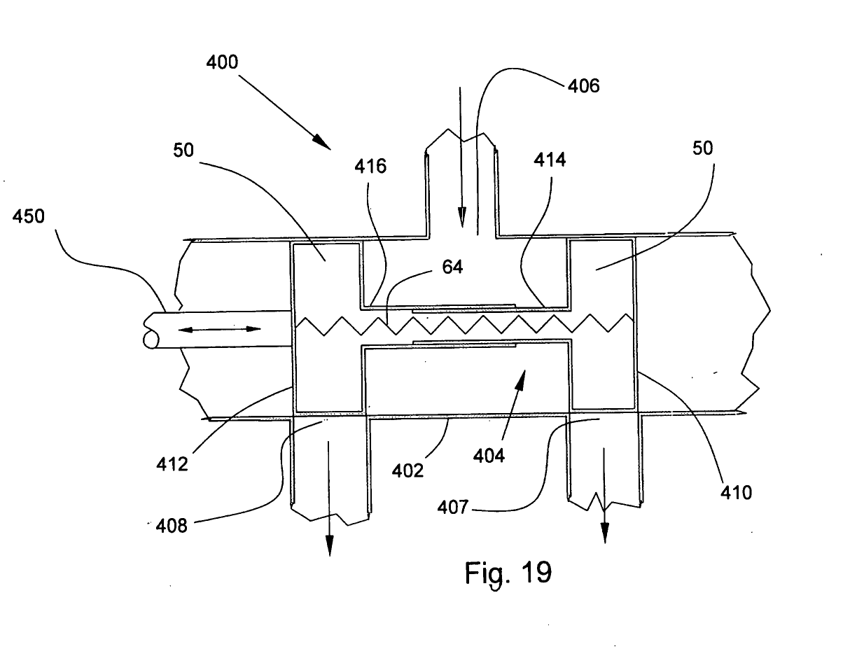

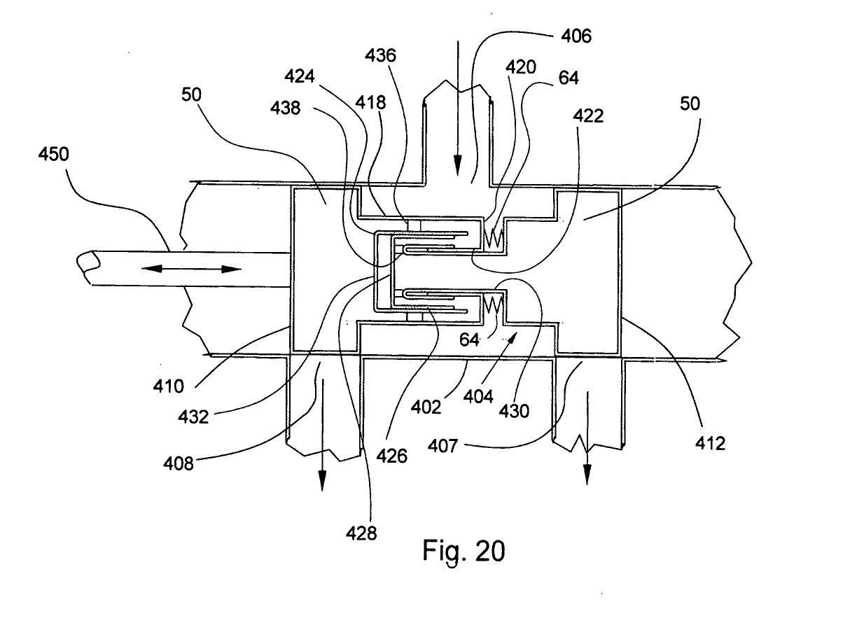

FIGS. 19 and 20 show further embodiments of the present invention wherein the temperature change of a thermally reactive material is used to control a spool valve. Referring now to FIG. 19, one embodiment of the present invention is shown comprising a spool valve shown generally at 400. The spool valve 400 comprises a cylindrical valve body 402 and a piston assembly shown generally at 404. The cylindrical valve body further includes inlet port 406 to permit the flow of a fluid into the valve body 402. The cylindrical valve body further includes first and second outlet ports 407 and 408 respectively to permit the flow of a fluid out of the valve body 402.

The piston assembly 404 comprises first and second hollow pistons 410 and 412 respectively having first and second sleeves 414 and 416, respectively, extending from the first and second hollow pistons. The first sleeve 414 of the first hollow piston is slidably and sealably received within the second sleeve 416 of the second hollow piston. The first and second hollow pistons comprise hollow bodies containing a thermally reactive material 50. The first and second sleeves comprise hollow cylindrical shapes having open ends and being in fluidic communication with their associated hollow pistons.

In operation, the first and second hollow pistons 410 and 412 may selectively block the first and second outlet ports 407 and 408. The piston rod is controlled by some external means related to the purpose of the spool valve. As shown in FIG. 19, both first and second outlet ports 407 and 408 are blocked by first and second hollow pistons 410 and 412. It will be apparent that movement of the piston assembly 404 in either direction by the piston rod 450 will unblock either outlet port 407 or port 408 while preventing fluid from reaching the other outlet port.

In addition, the piston assembly 404 transmits the temperature of the fluid to the thermally reactive material 50. The thermally reactive material expands or contracts in response to the temperature transmission in accordance with its coefficient of thermal expansion. The expansion of the thermally reactive material 50 will cause the first and second sleeves 414 and 416 to be slidably displaced relative to each other thereby increasing the length of the piston assembly. A corresponding contraction of the thermally reactive material will allow the spring 64 to displace the first and second sleeves slidably relative to each other thereby decreasing the length of the piston assembly. As a result of this decreased length, a greater movement of the piston rod will be needed to unblock either of the first or second outlet ports 407 or 408. Alternatively, the same movement of the piston rod will only partly unblock either the first or second outlet ports, allowing a throttled amount of fluid to pass through the partly opened port.

The purpose of the spool valve may be to throttle a controlled volume of a fluid through either of first or second outlet ports 407 or 408. The purpose of the spool valve may alternatively be to dispense fluid through first and second outlet ports 407 and 408 in a timed, alternating sequence. In this latter application, for a constant stroke length and velocity of the piston rod, the length of the piston assembly will affect the time during which each of the first and second outlet ports 407 and 408 are open. It will be appreciated that in addition to the arrangement shown in FIG. 19 the fluid may flow past the end faces of the pistons. In addition, the piston assembly may consist of more than two pistons and a plurality of corresponding inlet and outlet ports.

It will be appreciated that although the piston assembly is shown in FIG. 19 to be operable to increase in length in response to a temperature increase, it may also be possible to configure the piston assembly to decrease in length in response to a temperature change as shown in FIG. 20.

In FIG. 20, the piston assembly 404 comprises first and second hollow pistons 410 and 412, respectively. The first hollow piston 410 further includes a first diameter sleeve 418 extending perpendicularly from the first hollow piston 410. The first diameter sleeve includes an end wall 420 formed with a bore defined by an internal sleeve 422. Internal sleeve 422 is coaxial with the outer sleeve 418. The first hollow piston 410 further includes an internal cup 424 formed from an inner cylindrical wall 426 coaxial with first diameter sleeve 418 and a base 432 wherein the interior of internal cup 424 opens in the direction of the second hollow piston. The second hollow piston 412 includes a sleeve 430 extending perpendicularly from the second hollow piston towards the first hollow piston. The second hollow piston further includes a nested cup 428 that is received within the internal cup 424 of the first hollow piston. The distance from the first hollow piston to the inner cup 424 is fixed by struts 436. The distance from the second hollow piston to the nested cup 432 is fixed by struts 438.

In operation, a temperature from the fluid is transmitted to the thermally reactive material 50 contained within the hollow pistons which will accordingly expand in accordance with its coefficient of thermal expansion. The expansion of the thermally reactive material will cause the end wall 420 of the first hollow piston 410 and the nested cup 428 of the second hollow piston 412 to be pushed apart which will in turn cause the first and second hollow pistons to be pulled closer together thereby decreasing the length of the piston assembly. As a result of this decreased length, a greater movement of the piston rod will be needed to unblock either of the first or second outlet ports 407 or 408. Alternatively, the same movement of the piston rod will only partly unblock either the first or second outlet ports, allowing a throttled amount of fluid to pass through the partly opened port.

The purpose of the spool valve may be to throttle a controlled volume of a fluid through either of first or second outlet ports 407 or 408. The purpose of the spool valve may alternatively be to dispense fluid through first and second outlet ports 407 and 408 in a timed, alternating sequence. In this latter application, for a constant stroke length and velocity of the piston rod, the length of the piston assembly will affect the time during which each of the first and second outlet ports 407 and 408 are open.

In the representative embodiments described herein, the movement of the flow adjusting device may be rotary or linear. It will be appreciated that the movement of the flow adjusting device may also be a combination of rotary and linear movement. It will also be appreciated that the movement of the movable portion may be linear, rotary or a combination thereof.

It will be appreciated that in some embodiments of the present invention, the piston will only apply a force to operate the flow control apparatus in one direction. In some embodiments of the present invention there exists in the fluid control apparatus itself a means for applying an opposing force so as to reset the piston upon a contraction of the thermally reactive material. For example, in the throttling valves shown in FIGS. 12 to 15, the flow of the fluid may apply a force to the plunger 206 thereby urging the piston 218 back into the cylinder 216. Similarly, in the fluid propulsion device of FIGS. 1 to 8, the aerodynamic forces of the fluid may apply a rotational force to the blade or vane so as to urge the blade or vane to rotate in a direction wherein the piston is urged back into the cylinder. In these cases, no return force is necessary for the full controllability of the fluid control apparatus. The present invention may also include a resetting device that serves to reset the piston back into the cylinder. This device, such as a spring, may be necessary after the thermally reactive material has contracted when the vacuum force inside the cylinder is not sufficient to fully retract the piston alone.

It will be appreciated that the amount of a displacement caused on the piston is dependant upon the volume change in the thermally reactive material and the cross sectional area of the piston. Accordingly, one method for controlling the amount of piston displacement caused by a desired temperature change in the thermally reactive material is to select a piston cross sectional area that has a desired relationship to the volume of the reservoir. By this method, a relatively large displacement of the piston can be achieved by selecting a small cross section piston in conjunction with a correspondingly large volume reservoir thereby achieving a fluidic mechanical advantage. In some embodiments, the thermally reactive material may be displaced from a reservoir into a cylinder where the cross sections of the reservoir and the cylinder are not identical. In addition, the shapes of the reservoir and the shape of the cylinder may be different from each other. It will therefore be appreciated that the thermally reactive material would desirably have a viscosity so as to enable the thermally reactive material to flow from the reservoir into the cylinder and vice versa. Accordingly, many types of materials are acceptable for use as the thermally reactive material such as, without limiting the generality of the following, liquids, gasses, granules, foam, emulsion, plasma, and some solids etc.

It will be appreciated that the thermally reactive material may advantageously be chosen to aid in the sealing of the movable portion in the opening of the reservoir. It will therefore be apparent that the thermally reactive material may advantageously be comprised of grease. A further advantage of the selection of grease for the thermally reactive material is that the grease may be replenished in the reservoir by commonly available commercial means such as by means of a grease gun.

It will be appreciated that while any change in the temperature of the thermally reactive material may cause a change in the volume of the thermally reactive material, the temperature change may also cause a change in the pressure in the thermally reactive material or a combination of a volume and pressure change. It will therefore be appreciated that although the embodiments of the present invention disclose the use of a volume change in the thermally reactive material, a change in pressure may also be used to move a movable portion so as to vary the flow of a fluid through a device.

The present description discusses blades of a fan as a representative embodiment. It will be understood that the term blade is a common term for the discussion of fans in general. It will also be understood that the term vane may be common to the discussion of other types of fluid propulsion devices such as pumps, turbines or compressors. Accordingly it will be appreciated that the terms blade or vane in the present description refer to any of several usually relatively thin, rigid, flat, or sometimes curved surfaces radially mounted along an axis, that is turned by or used to move a fluid.

While specific embodiments of the invention have been described and illustrated, such embodiments should be considered illustrative of the invention only and not as limiting the invention as construed in accordance with the accompanying claims.

What is claimed is:

1. A method of controlling the flow of a fluid past a device having a flow adjusting device, the method comprising:
transmitting a temperature to a thermally reactive material having a coefficient of thermal expansion which produces a volume change in said thermally reactive material in response to a change in the temperature, said thermally reactive material being enclosed within a container having a movable portion which is moved in response to said volume change of said thermally reactive material; and
applying movement of said movable portion to actuate said flow adjusting device.

2. The method of claim 1 wherein an increase in the temperature causes a corresponding increase in the flow rate of the fluid.

3. The method of claim 1 wherein an increase in the temperature causes a corresponding decrease in the flow rate of the fluid.

4. The method of claim 1 wherein said temperature is the temperature of the fluid.

5. The method of claim 1 wherein said temperature is an external temperature.

6. The method of claim 1 wherein said temperature is an average of an external temperature and the temperature of the fluid.

7. The method of claim 1 wherein said flow adjusting device comprises a throttle for throttling the flow of said fluid.

8. The method of claim 1 wherein said flow adjusting device comprises a pitch controller for controlling the pitch of a vane of a fluid propulsion device.

9. The method of claim 1 wherein said flow adjusting device comprises a vane length controller for controlling the length of a vane of a fluid propulsion device.

10. An apparatus for controlling the flow of a fluid past a flow controller having a flow adjusting device, the apparatus comprising:
a reservoir housing a thermally reactive material having a coefficient of thermal expansion to cause a constant phase volume change in said thermally reactive material in response to a change in temperature, said reservoir being adapted to transmit a temperature to said thermally reactive material;
a movable portion associated with said thermally reactive material wherein said volume change of said thermally reactive material causes a corresponding movement of said movable portion; and
wherein said movable portion actuates said flow adjusting device to vary said flow of said fluid in response to movement of said movable portion.

11. The apparatus of claim 10 wherein said reservoir is positioned adjacent the fluid and the temperature transmitted to the thermally reactive material is the temperature of the fluid.

12. The apparatus of claim 10 wherein said reservoir is positioned external to the fluid and the temperature transmitted to the thermally reactive material is an external temperature.

13. The apparatus of claim 10 wherein said reservoir includes a portion positioned adjacent the fluid and a portion positioned external to the fluid and the temperature transmitted to the thermally reactive material is the temperature of the fluid or an external temperature.

14. The apparatus of claim 10 wherein said thermally reactive material comprises a grease.

15. The apparatus of claim 10 further including a biasing force member for urging said movable portion in a direction opposite to said movement of said movement of said movable portion caused by said volume change of said thermally reactive material.

16. The apparatus of claim 15 wherein said biasing force member comprises a spring.

17. The apparatus of claim 10 wherein said flow controller comprises a fluid propulsion device.

18. The apparatus of claim 17 wherein said fluid propulsion device further includes at least one vane having a pitch, each of said at least one vanes further having a shaft having an axis.

19. The apparatus of claim 18 wherein said flow adjusting device of said fluid propulsion device further comprises a pitch adjusting device for adjusting said pitch of said at least one vane about said axis of said at least one vane.

20. The apparatus of claim 19 wherein said reservoir circumferentially surrounds said vane shaft.

21. The apparatus of claim 20 wherein said pitch adjusting device comprises said movable portion being operable to engage a portion of said vane shaft so as to rotate said vane shaft thereby changing said pitch of said vane in response to said movement of said movable portion.

22. The apparatus of claim 21 wherein said movable portion is integral with said vane shaft.

23. The apparatus of claim 21 wherein an increase in the temperature of said thermally reactive substance causes said movable portion to increase the pitch of said vanes.

24. The apparatus of claim 21 wherein an increase in the temperature of said thermally reactive substance causes said movable portion to decrease the pitch of said vanes.

25. The apparatus of claim 19 wherein said fluid propulsion device further comprises a hub, wherein said pitch adjusting device rotatably connects said vane to said hub.

26. The apparatus of claim 25 wherein said reservoir is positioned within said hub.

27. The apparatus of claim 19 wherein said fluid propulsion device further includes a stator, wherein said pitch adjusting device rotatably connects said at least one vane to said stator.

28. The apparatus of claim 10 wherein said flow controller comprises a flow regulator.

29. The apparatus of claim 28 wherein said flow regulator comprises a valve wherein said flow adjusting device comprises a plunger operable to vary a distance between said plunger and a cooperating valve seat.

30. The apparatus of claim 29 wherein an increase in the temperature of said thermally reactive substance causes said plunger to move towards said valve seat.

31. The apparatus of claim 29 wherein an increase in the temperature of said thermally reactive substance causes said plunger to move way from said valve seat.

32. The apparatus of claim 28 wherein said flow regulator comprises first and second restrictor plates each restrictor plate having at least one aperture wherein the apertures of said first and second restrictor plates may be adjustably aligned.

33. The apparatus of claim 32 wherein said first and second restrictor plates are rotatable with respect to each other so as to enable said apertures of said first and second restrictor plates to be rotatably adjustably aligned.

34. The apparatus of claim 33 wherein said first and second restrictor plates are substantially circular.

35. The apparatus of claim 34 wherein an increase of the temperature of said thermally reactive substance causes said apertures of said first and second restrictor plates to become more aligned.

36. The apparatus of claim 34 wherein an increase of the temperature of said thermally reactive substance causes said apertures of said first and second restrictor plates to become less aligned.

37. The apparatus of claim 28 wherein said flow regulator comprises a hollow body containing said thermally reactive material received within a cylinder having a plurality of apertures, the hollow body having first and second spaced apart hollow cylinders connected by an expandable portion, said first and second spaced apart hollow cylinders being operable to selectively block said plurality of apertures.

38. The apparatus of claim 37 wherein said expandable portion is operable to increase in length in response to an increase in the temperature of said thermally reactive material.

39. The apparatus of claim 37 wherein said expandable portion is operable to decrease in length in response to an increase in the temperature of said thermally reactive material.
